(19) United States
(12) Patent Application Publication
(10) Pub. No.: US 2025/0240187 A1
(43) Pub. Date: Jul. 24, 2025

(54) Network Device with High Bandwidth Packet Processing Capabilities

(71) Applicant: Arista Networks, Inc., Santa Clara, CA (US)

(72) Inventors: Thomas Dejanovic, Sydney (AU); Callum Hunter, Sydney (AU)

(21) Appl. No.: 18/419,230

(22) Filed: Jan. 22, 2024

(51) Int. Cl. H04L 12/64

(52) U.S. Cl. CPC H04L 12/6418; H04L 2012/6435; H04L 2012/6459

(57) ABSTRACT

A method of operating a network device is provided. The method can include obtaining incoming data packets, conveying the incoming data packets through a parallel data bus, and using a demultiplexer to split the incoming data packets being conveyed through the parallel data bus onto a plurality of separate independent data paths within the network device. The method can further include using a multiplexer to aggregate or merge data packets from the plurality of data paths onto an egress parallel data bus.

### BACKGROUND

A network device can be configured to receive a data packet via an ingress port and to route the data packet to a corresponding egress port. The ingress port and the egress port can be coupled to other devices in a network via a network interface that is configured to convey data packets in a serial fashion. The data packet traversing the network device can, however, be conveyed through a parallel data bus coupling the ingress port to the corresponding egress port.

It can be challenging to design such a parallel data bus within a network device. High bandwidth network interfaces typically require wide parallel data buses within the network device. As the parallel data bus width increases, however, the efficiency of the data bus can decline when the data packets exhibit lengths that are not integer multiples of the data bus width. It is within such context that the embodiments herein arise.

### BRIEF DESCRIPTION OF THE DRAWINGS

FIG. 1 is a diagram of an illustrative network device configured to route data packets in accordance with some embodiments.

FIG. 2 is a diagram of an illustrative network device having ingress and egress pipelines coupled to physical ports via network interface circuitry in accordance with some embodiments.

FIG. 3 is a diagram illustrating how data can be split into multiple data planes in a network device in accordance with some embodiments.

FIG. 4 is a diagram showing illustrative steps for operating a network device of the type shown in FIGS. 1-3 in accordance with some embodiments.

FIG. 5 is a diagram showing how incoming data packets can be routed into two or more separate data planes in accordance with some embodiments.

FIG. 6 is a diagram showing how data packets from at least two data planes can be aggregated together in accordance with some embodiments.

FIG. 7 is a diagram showing aggregated data packets having no gaps in accordance with some embodiments.

### DETAILED DESCRIPTION

An aspect of the disclosure provides a method of operating a network device that includes obtaining incoming data packets, conveying the incoming data packets through a parallel data bus, and using a demultiplexer to split the incoming data packets being conveyed through the parallel data bus onto a plurality of separate data paths within the network device. The method can further include packing the incoming data packets back-to-back on the parallel data bus. The demultiplexer can route the incoming packets onto the separate data paths in an alternating or ping pong fashion. The method can further include using a multiplexer to aggregate data packets from the plurality of data paths onto an egress parallel data bus. At least some of the data packets being aggregated onto the egress parallel data bus can be separated by one or more gaps. At least some of the data packets being aggregated onto the egress parallel data bus may not be separated by any gaps.

An aspect of the disclosure provides a network device that includes one or more ingress ports, a network interface receiver coupled to the one or more ingress ports and configured to output incoming data packets, a demultiplexing circuit configured to receive the incoming data packets from the network interface receiver and to split the incoming data packets into two or more independent data planes, a multiplexing circuit configured to aggregate data packets being conveyed through the two or more independent data planes, a network interface transmitter configured to receive the aggregated data packets from the multiplexing circuit, and one or more egress ports coupled to the network interface transmitter. Configuring and operating a network device in this way can be technically advantageous and beneficial to maintain line rate for small data packets for high data transmission rates (e.g., to maintain the efficiency and data bus utilization rate for 10 Gb Ethernet, 40 Gb Ethernet, 100 Gb Ethernet, or other high speed networking protocols).

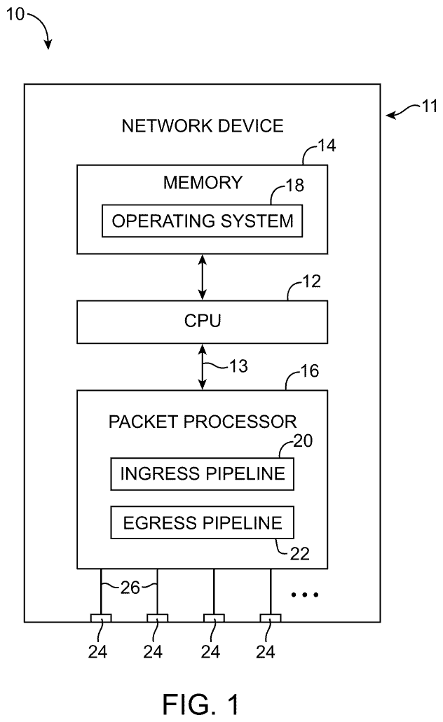

FIG. 1 is a diagram of a network device such as network device 10 configured to route data packets. Network device 10 may be a router, a switch, a bridge, a hub, a repeater, a firewall, a device serving other networking functions, a network device that includes a combination of these functions, or other types of network elements. As shown in FIG. 1, network device 10 may include processing circuitry such as central processing unit (CPU) 12, storage circuitry including memory 14, and a packet processing circuit such as packet processor 16 all disposed within housing 11 of device 10. Housing 11 may be an exterior cover (e.g., a plastic exterior shell, a metal exterior shell, or an exterior shell formed from other rigid or semirigid materials) that provides structural support and protection for the components disposed within the housing. In general, processing unit 12 may represent processing circuitry based on one or more microprocessors, graphics processing units (GPUs), host processors, general-purpose processors, microcontrollers, digital signal processors, application-specific integrated circuits (ASICs), application-specific system processors (ASSPs), programmable logic devices such as field-programmable gate arrays (FPGAs), power management integrated circuits (PMICs), a combination of these processors, or other types of processors. Central processing unit 12 may sometimes be referred to herein as main processor 12.

Main processor 12 may be used to run a network device operating system such as operating system (OS) 18 and/or other software/firmware that is stored on memory 14. Memory 14 may include non-transitory (tangible) computer readable storage media that stores operating system 18 and/or any software code, sometimes referred to as program instructions, software, data, instructions, or code. Memory 14 may include nonvolatile memory (e.g., flash memory or other electrically-programmable read-only memory configured to form a solid-state drive), volatile memory (e.g., static or dynamic random-access memory), hard disk drive storage, and/or other storage circuitry. The processing circuitry and storage circuitry described above are sometimes referred to collectively as control circuitry. Processor 12 and memory 14 are sometimes referred to as being part of a “control plane” of network device 10.

Operating system 18 running in the control plane of network device 10 may exchange network topology information with other network devices using a routing protocol. Routing protocols are software mechanisms by which multiple network devices communicate and share information about the topology of the network and the capabilities of each network device. For example, network routing protocols executed on device 10 may include Border Gateway Protocol (BGP) or other distance vector routing protocols, Enhanced Interior Gateway Routing Protocol (EIGRP), Exterior Gateway Protocol (EGP), Routing Information Protocol (RIP), Open Shortest Path First (OSPF) protocol, Label Distribution Protocol (LDP), Multiprotocol Label Switching (MPLS), intermediate system to intermediate system (IS-IS) protocol, Protocol Independent Multicast (PIM), Virtual Routing Redundancy Protocol (VRRP), Hot Standby Router Protocol (HSRP), and/or other Internet routing protocols (just to name a few).

Processor 12 may be coupled to packet processor 16 via path 13. Packet processor 16 is oftentimes referred to as being part of a “forwarding plane” or “data plane.” Packet processor 16 may represent processing circuitry based on one or more network processing units, microprocessors, general-purpose processors, application specific integrated circuits (ASICs), programmable logic devices such as field-programmable gate arrays (FPGAs), a combination of these processors, or other types of processors. Packet processor 16 may be coupled to input-output ports 24 via paths 26 and receives and outputs data packets via input-output ports 24. Ports 24 that receive data packets from other network elements are sometimes referred to as ingress ports, whereas ports 24 through which packets exit out of device 10 towards other network elements are sometimes referred to as egress ports. Ports 24 are sometimes referred to collectively as ingress-egress ports and can represent physical ports and/or logical ports.

Packet processor 16 can analyze the received data packets, process the data packets in accordance with a network protocol, and forward (or optionally drop) the data packets accordingly. Data packets received in the forwarding plane may optionally be analyzed in the control plane to handle more complex signaling protocols. Memory 14 may include information about the speed(s) of input-output ports 24, information about any statically and/or dynamically programmed routes, any critical table(s) such as forwarding tables or forwarding information base (FIB), critical performance settings for packet processor 16, other forwarding data, and/other information that is needed for proper function of packet processor 16.

A data packet is generally a formatted unit of data conveyed over a network. Data packets conveyed over a network are sometimes referred to as network packets. A group of data packets intended for the same destination should have the same forwarding treatment. A data packet typically includes control information and user data (payload). The control information in a data packet can include information about the packet itself (e.g., the length of the packet and packet identifier number) and address information such as a source address and a destination address. The source address represents an Internet Protocol (IP) address that uniquely identifies the source device in the network from which a particular data packet originated. The destination address represents an IP address that uniquely identifies the destination device in the network at which a particular data packet is intended to arrive.

Data packets received in the data plane may optionally be analyzed in the control plane to handle more complex signaling protocols. Packet processor 16 may be configured to partition data packets received at an ingress port 24 into groups of packets based on their destination address and to choose a next hop device for each data packet when exiting an egress port 24. The choice of next hop device for each data packet may occur through a hashing process (as an example) over the packet header fields, the result of which is used to select from among a list of next hop devices in a routing table stored on memory in packet processor 16. Such a routing table listing the next hop devices for different data packets is sometimes referred to as a hardware forwarding table or a hardware forwarding information base (FIB). The example of FIG. 1 showing four ingress-egress ports 24 is merely illustrative. In general, packet processor 16 can be coupled to up to ten input-output ports 24, up to twenty input-output ports 24, up to thirty input-output ports 24, up to fifty input-output ports 24, up to a hundred input-output ports 24, or more than a hundred input-output ports 24.

Packet processing block 16 of FIG. 1 may generally represent one or more packet processors. Each packet processor 16 may include one or more packet processing pipelines that include an ingress pipeline 20 and an egress pipeline 22. Each port 24 may be associated with its own ingress pipeline 20 and its own egress pipeline 22. Data packets received at an ingress port 24 may be processed by an ingress pipeline 20 associated with that ingress port, whereas data packets transmitted from an egress port 24 may be processed using an egress pipeline 22 associated with that egress port. Ingress pipeline 20 may forward a data packet to egress pipeline 22 corresponding to a port 24 on which the packet will egress from device 10. Ingress pipeline 20 may include selection circuitry (sometimes referred to as a selector) configured to direct an intermediate data packet and associated metadata produced in the ingress pipeline to an appropriate egress pipeline 22. The selector within ingress pipeline 20 can select an egress pipeline 22 based on information contained in the received data packet.

In some embodiments, network device 10 can be based on a scalable architecture that includes multiple interconnected network chips where the packet processing functionality is distributed between separate ingress and egress pipelines. For example, ingress pipeline 20 and egress pipeline 22 can be implemented using separate logic circuitry. As another example, ingress pipeline 20 and egress pipeline 22 can be implemented as part of separate integrated circuit (IC) chips.

Ingress pipeline 20 can include a parser and a processing engine, sometimes referred to as an ingress parser and an ingress processing engine, respectively. Ingress pipeline 20 can use ingress lookup and editing tables (sometimes referred to as ingress data tables) to provide editing instructions based on the contents of an ingress data packet to drive the ingress processing engine. Generally, when a data packet is received on a port 24 of network device 10, the received data packet feeds into an ingress pipeline 20 associated with that port 24. The parser of that ingress pipeline 20 parses the received data packet to access portions of the data packet. The parsed information can be used as search/lookup keys into ingress data tables to produce metadata that is then used to identify a corresponding egress pipeline and to direct processing in the egress pipeline (e.g., to bridge or route the data packet, to selectively add a tunnel header, etc.).

In some instances, lookup operations can be performed using the ingress data tables to obtain editing instructions that feed into the processing engine to direct editing actions on the data packet. In other instances, the ingress packet might not be edited. In either scenario, the data packet output from an ingress pipeline can sometimes be referred to herein as an “intermediate packet.” The intermediate data packet and the metadata output from an ingress pipeline can be forwarded by its associated selector and queued towards an appropriate egress pipeline. In some embodiments, the selector can select the egress pipeline based on information contained in the metadata and/or information contained in the ingress data packet.

Egress pipeline 22 can include its own parser and processing engine. The egress pipeline can include a parser and a processing engine, sometimes referred to as an egress parser and an egress processing engine, respectively. The egress pipeline can access egress lookup and editing tables (sometimes referred to as egress data tables) to provide editing instructions to the egress processing engine. Generally, when the selector transmits the intermediate data packet from the ingress pipeline to the egress pipeline, the egress parser of the egress pipeline can parse the received intermediate packet to access portions of that packet. Various lookups can be performed on the egress data tables using the parsed data packet and the metadata to obtain appropriate editing instructions that feed into the egress processing engine. The editing instructions can direct actions performed by the egress processing engine to produce a corresponding egress data packet.

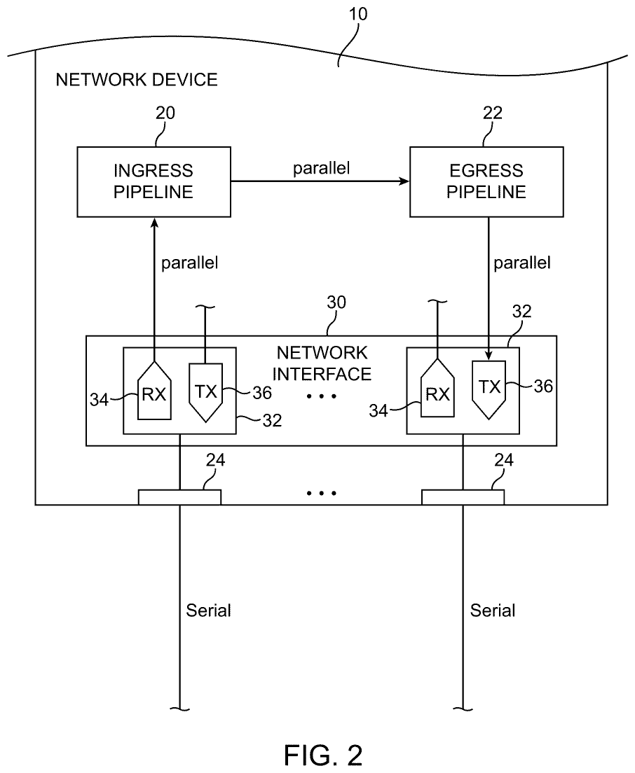

FIG. 2 is a diagram of illustrative network device 10 having ingress and egress pipelines coupled to physical ports 24 via network interface circuitry 30. As shown in FIG. 2, network interface circuitry 30 may include a plurality of network interface blocks such as network interface blocks 32. Each network interface block 32 may be coupled to one or more input-output port(s) 24. If desired, each input-output port 24 can optionally be coupled to more than one network interface block 32. Network interface block 32 can include a receiving (RX) component such as receiver 34 and can also include transmitting (TX) component such as transmitter 36. A network interface block 32 that includes receiver and transmitter components can therefore sometimes be referred to as a network interface transceiver.

Each transceiver can include a physical (PHY) layer subcomponent that is configured to handle the actual transmission of data over a physical medium. For example, the PHY layer can define the hardware characteristics of the physical transmission medium (e.g., copper cables, fiber-optic cables, or wireless communication frequencies), be responsible for encoding data into bits for transmission and decoding received bits back into data (e.g., by defining a modulation scheme or signaling method used for representing binary data on the physical medium), determine a bit rate at which bits are being transmitted over the network and the overall bandwidth required for the transmission, manage transmission power levels to ensure that signals sufficiently reach their intended destination without causing excessive interference with other signals, include a mechanism for serializing and de-serializing signals, ensure synchronization of bits between transmitting and receiving components, handle clock recovery operations, perform serialization of data for transmission, and/or provide other foundation for higher layer networking protocols to operate while enabling data to be reliably transmitted over the network.

Each transceiver can further include a media access control (MAC) layer subcomponent that sits above the PHY layer and that is configured to control access to the physical network medium. For example, the MAC layer can assign hardware/MAC addresses for uniquely identifying devices on a network, define the structure of data frames for encapsulating data to be transmitted over the network (e.g., by defining source and destination address fields, data payload, error checking information, etc.), define ways or protocols for avoiding data collision while ensuring efficient data transfer, manage flow control mechanism for minimizing congestion, provide error detection mechanisms to identify and handle data transmission errors (e.g., via checksums or cyclic redundancy checks), provide quality of service (QoS) functions, and/or provide other ways for managing access to the network medium while ensuring reliable and efficient transmission of data frames between devices in a network.

As shown in FIG. 2, data bits conveyed over the network may be transmitted in a serial fashion. Data bits arriving at an ingress port 24 may be serial data bits. Data bits being output by an egress port 24 may also be serial data bits. Network device 10 may, however, convert the serial data bits in parallel data for processing within device 10. The data packets being routed or traversing through network device 10 may be conveyed through a parallel data bus (or path). The parallel data bus may convey one or more data packets output from a receiver 34 in a first network interface block 32 to a corresponding ingress pipeline 20, may convey one or more data packets from ingress pipeline 20 to a corresponding egress pipeline 22, and may convey one or more data packets from the egress pipeline 22 to a corresponding transmitter 36 in a second network interface block 32 coupled to an egress port 24.

High bandwidth network interfaces such as network interfaces capable of supporting link rates of at least 10 Gbps (gigabits per second), 10-40 Gbps, 40-100 Gbps, or more than 100 Gbps may require wide parallel data paths in a network device. As the data path width increases, however, the efficiency might decline due to data packets not having lengths that are integer multiples of the data path width. This can sometimes result in scenarios where only n bytes of an m byte wide data path (bus) is utilized. For large data packets, this may not be an issue because the unused portion might only represent a small portion of the total data on the parallel data bus. For example, consider a scenario in which a 64 byte data packet is being conveyed through an 8 byte parallel data bus. Here, the 64 byte data packet will be transmitted through the 8 byte parallel data bus as 8 separate segments over 8 cycles, thus yielding 100% efficiency because every part of the 8 byte parallel data bus is being occupied in all 8 cycles.

As another example, consider a different scenario in which a 65 byte data packet is being conveyed through the same 8 byte parallel data bus. Here, the 65 byte data packet will be transmitted through the 8 byte parallel data bus as 9 separate segments over 9 cycles. Because the 8 byte parallel data bus can potentially transport a maximum of 72 bytes over 9 cycles, the data bus therefore yields only 90.28% efficiency (i.e., 65 divided by 72) because 7 of the 8 available bytes in the parallel data bus are not being utilized in the 9^{th} cycle.

As another example, consider a different scenario in which a 65 byte data packet is being conveyed through a 16 byte parallel data bus. Here, the 65 byte data packet will be transmitted through the 16 byte parallel data bus as 5 separate segments over 5 cycles. Because the 16 byte parallel data bus can potentially transport a maximum of 80 bytes over 5 cycles, the data bus therefore yields only 81.25% efficiency (i.e., 65 divided by 80) because 15 of the 16 available bytes in the parallel data bus are not being utilized in the 5^{th} cycle.

As another example, consider a different scenario in which a 65 byte data packet is being conveyed through a 32 byte parallel data bus. Here, the 65 byte data packet will be transmitted through the 32 byte parallel data bus as 3 separate segments over 3 cycles. Because the 32 byte parallel data bus can potentially transport a maximum of 96 bytes over 3 cycles, the data bus therefore yields only 67.71% efficiency (i.e., 65 divided by 96) because 31 of the 32 available bytes in the parallel data bus are not being utilized in the 3^{rd} cycle.

These examples illustrate how the efficiency problem is exacerbated as the length of the data packets becomes smaller relative to the width of the parallel data bus. Such reduction in efficiency or data bus utilization rate can be compensated by operating the parallel data bus at a higher frequency, by stripping or compressing parts of the data packets to reduce the total number of cycles, or by further increasing the width of the parallel data bus. These approaches, however, have limitations. For instance, the clock frequency typically has to run at or near the maximum operating frequency of the packet processor or main processor. Compressing an already small data packet has diminishing marginal gains. Furthermore, increasing the width of the parallel data bus will further reduce transmission/processing efficiency for small data packets.

In accordance with an embodiment, a method and associated circuitry are provided for splitting a data path into two or more independent data paths within network device 10. Received data packets can be packed back-to-back onto a parallel data bus. The packed back-to-back data packets on the parallel data bus can then be split into multiple independent data paths, which effectively doubles the internal bandwidth for buffering, filtering, switching, and/or otherwise processing the data packets. The processed data packets on the independent data paths can then be aggregated back to a parallel data bus for egress. Configuring and operating network device 10 in this way can be technically advantageous and beneficial to maintain line rate for small data packets for high data transmission rates (e.g., to maintain the efficiency and data bus utilization rate for 10 Gb Ethernet, 40 Gb Ethernet, 100 Gb Ethernet, or other high speed networking protocols).

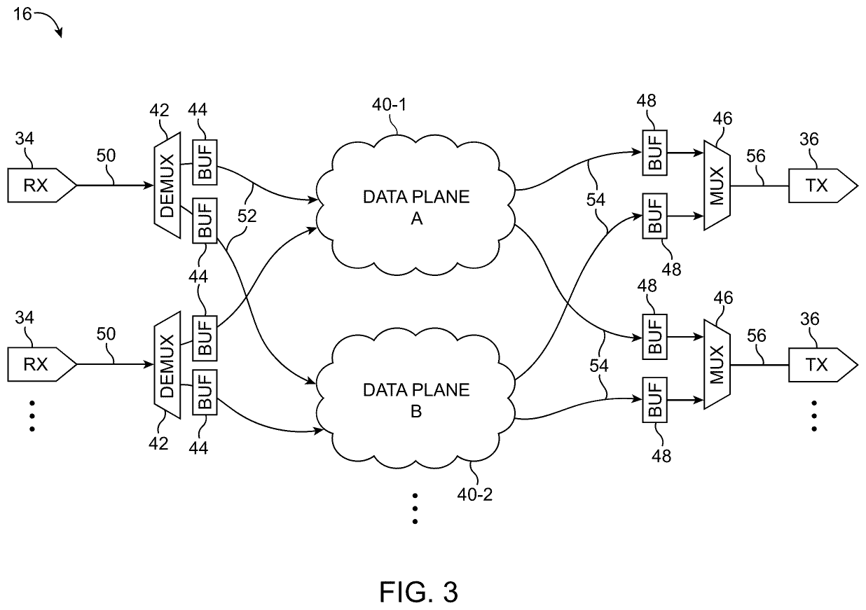

FIG. 3 is a diagram showing illustrative circuitry that can be included as part of a packet processor 16 within network device 10. As shown in FIG. 3, incoming data bits received via an ingress port can be conveyed to one or more network interface receiver (RX) components 34. Receiver component 34 can be configured to decode the incoming data bits and to output corresponding data packets. Receiver component 34 can be configured to pack the decoded data packets in a back-to-back arrangement on a parallel data bus 50. The terminology “back-to-back” when referring to successive data packets may be defined herein as an arrangement in which consecutive data packets are packed onto parallel data bus 50 such that no gaps exist between successive data packets (e.g., the end-of-packet of a first data packet is immediately followed by the start-of-packet of a second subsequent data packet without any gaps or unutilized bytes in bus 50). Parallel data bus 50 in which successive data packets or segments are tightly packed in such back-to-back arrangement is sometimes referred to herein as a segmented data bus.

The data packets on parallel data bus 50 can be split into two or more data planes using a demultiplexing circuit such as demultiplexer 42. Demultiplexer 42 can have a first output coupled to a first data plane 40-1 via a first internal routing path 52 and can have a second output coupled to a second data plane 40-2 via a second internal routing path 52. The outputs of each demultiplexer 42 can optionally be coupled to ingress buffers 44. Ingress buffers 44 can be configured to buffer packets being conveyed from demultiplexer 42 to first data plane 40-1 and to second data plane 40-2. First data plane 40-1 is sometimes referred to as a first data path, whereas second data plane 40-2 is sometimes referred to as a second data path. Assuming segmented parallel data bus 50 is m bytes wide, then each internal routing path 52 can also be m bytes wide.

Demultiplexer 42 can forward the data packets to data planes (paths) 40-1 and 40-2 in an alternating or “ping pong” fashion. For example, odd data packets can be routed to data plane 40-1, whereas even data packets can be routed to data plane 40-2, or vice versa. Data planes 40-1 and 40-2 can operate independently, performing any packet switching or forwarding function that is needed for delivering the data packets to the corresponding multiplexer 46 for egress (e.g., the data planes can represent at least part of the ingress and/or egress pipelines). Demultiplexer 42 can contain at least one data bus width of ingress buffering in order to align the incoming data packets for the internal buses 52. Demultiplexer 42 can optionally provide larger ingress buffering as needed by the packet switching/forwarding function being performed at data plane 40-1 or data plane 40-2. The demultiplexer 42 and the associated ingress buffer 44 may collectively be considered part of the network interface receiver 34 or may be considered part of the ingress pipeline. Having at least two data planes effectively doubles the bandwidth of the packet processing pipeline without reducing the efficiency of transporting small(er) data packets.

The example above in which demultiplexer 42 forwards the data packets in a 1:1 alternating (ping pong) fashion is merely illustrative. As another example, demultiplexer 42 can optionally be configured to forward the data packets in a 2:2 alternating fashion, where two consecutive packets are forwarded to data plane 40-1, where the next two consecutive packets are forwarded to data plane 40-2, and so on. As another example, demultiplexer 42 can optionally be configured to forward the data packets in a 3:3 alternating fashion, where three consecutive packets are forwarded to data plane 40-1, where the next three consecutive packets are forwarded to data plane 40-2, and so on. If desired, other ways of splitting or distributing the data packets can be employed. For instance, an uneven packet splitting approach can optionally be employed, where more packets are being forwarded to data plane 40-1 than to data plane 40-2, or vice versa (e.g., the distribution of packets between the multiple data planes need not be equal).

The data packets from the multiple data planes can be conveyed to one or more multiplexing circuits such as multiplexers 46. In the example of FIG. 3, a first multiplexer 46 may have a first input configured to receive data packets from first data plane 40-1 via a first internal parallel data bus 54 and may have a second input configured to receive data packets from second data plane 40-2 via a second internal parallel data bus 54. Similarly, a second multiplexer 46 may have a first input configured to receive data packets from first data plane 40-1 via a third internal parallel data bus 54 and may have a second input configured to receive data packets from second data plane 40-2 via a fourth internal parallel data bus 54. In other words, data packets from the multiple data planes can be aggregated onto a single parallel data bus 56 coupled at the output of multiplexer 46. Parallel data bus 56 can be referred to and defined herein as an egress parallel data bus. Parallel data bus 50 can be referred to and defined herein as an ingress parallel data bus. In some embodiments, ingress parallel data bus 50 and egress parallel data bus 56 can have the same (equal) bus width. In other embodiments, ingress parallel data bus 50 and egress parallel data bus 56 can have different bus widths and can be clocked at different rates. In general, the bus width of egress data bus 56 may be equal to or greater than the bus width of data plane 40-1 or data plane 40-2.

Multiplexer 46 can aggregate the data packets from the various data planes in an alternating or “ping pong” fashion. For example, a data packet routed from the first data plane 40-1 may be followed by a data packet routed from the second data plane 40-2, whereas a data packet routed from the second data plane 40-2 may be followed by a data packet routed from the first data plane 40-1. Each multiplexer 46 may contain egress buffering (see, e.g., egress buffers 48) and/or may make use of flow control algorithms to control the flow of data packets from the switching/forwarding function being performed by the data planes. If desired, egress buffers 48 can additional or alternatively be disposed at the output of each multiplexer 46.

The aggregated data packets produced at the output of multiplexer 46 may be conveyed to a corresponding network interface transmitter 36 via parallel data bus 56. Parallel data bus 56 may be a segmented data bus where consecutive data packets are packed back-to-back with no gaps or with a minimal amount of gaps. Multiplexer 46 and the associated egress buffers 48 may collectively be considered part of the network interface transmitter 36 or may be considered part of the egress pipeline. Transmitter 36 may not provide any flow control functions and can stream out data bits at the requisite line rate. Assuming each internal routing path 54 is m bytes wide, then parallel data bus 56 can also be m bytes wide. The size of segmented parallel data bus 56 can optionally be sized to at least match the requisite line rate. Transmitter 46 can be configured to run at multiple line rates. As an example, transmitter 46 can be configured to output or egress data bits at 1 Gbps. As another example, transmitter 46 can be configured to output or egress data bits at 10 Gbps. As another example, transmitter 46 can be configured to output or egress data bits at 25 Gbps. As another example, transmitter 46 can be configured to output or egress data bits at 40 Gbps. As another example, transmitter 46 can be configured to output or egress data bits at more than 40 Gbps. As another example, transmitter 46 can be configured to output or egress data bits at 40-100 Gbps. As another example, transmitter 46 can be configured to output or egress data bits at more than 100 Gbps.

The example of FIG. 3 in which data from the ingress receivers 34 is conveyed to one or more of the egress transmitters 36 via at least two separate (parallel) data planes is illustrative. As another example, the data packets from the ingress receivers 34 can be routed to one or more of the egress transmitters 36 via three or more separate (parallel or independent) data planes or paths. As another example, the data packets from the ingress receivers 34 can be routed to one or more of the egress transmitters 36 via four or more separate (parallel or independent) data planes or paths. As another example, the data packets from the ingress receivers 34 can be routed to one or more of the egress transmitters 36 via five or more separate (parallel or independent) data planes or paths. As another example, the data packets from the ingress receivers 34 can be routed to one or more of the egress transmitters 36 via six or more separate (parallel or independent) data planes or paths. The demultiplexers 42 and multiplexers 46 can be configured accordingly to perform the desired switching depending on the number of independent data planes within the packet processor of device 10. For embodiments with more than two data planes, a round robin mechanism can be employed to forward the data packets onto the three or more data planes.

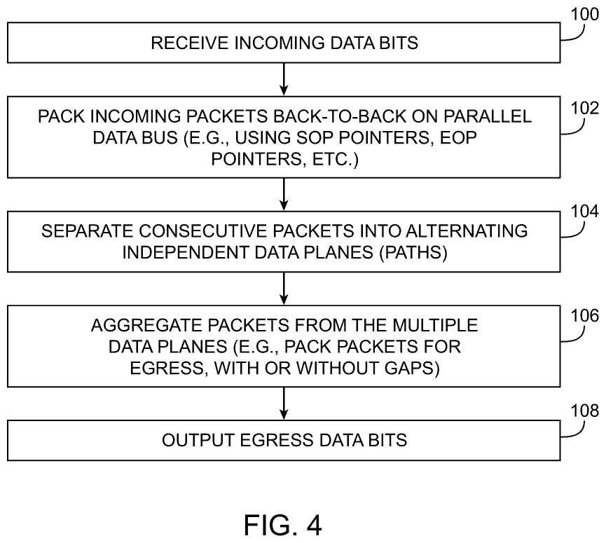

FIG. 4 is a diagram showing illustrative steps for operating a network device 10 of the type described in connection with FIGS. 1-3. During the operations of block 100, network device 10 can receive incoming data bits at an ingress port 24. The data bits may be conveyed to a network interface receiver 34. Network interface receiver 34 may decode the incoming data bits to produce corresponding data packets.

During the operations of block 102, network interface receiver 34 may pack the data packets back-to-back on a parallel data bus 50. Parallel data bus 50 in which successive data packets or segments are tightly packed in such back-to-back arrangement is sometimes referred to herein as a segmented data bus or a segmented parallel data bus.

During the operations of block 104, successive data packets on the segmented parallel data bus 50 may be separated into at least two independent data planes (see, e.g., FIG. 3) in an alternating fashion. For example, an ingress demultiplexer 42 can be configured to route even data packets to data plane 40-1 via first internal routing path 52 and to route odd data packets to data plane 40-2 via second internal routing path 52 in a ping pong fashion. As another example, ingress demultiplexer 42 can be configured to route odd data packets to data plane 40-1 via first internal routing path 52 and to route even data packets to data plane 40-2 via second internal routing path 52 in an alternating fashion.

During the operations of block 106, the data packets from the various independent data planes can be aggregated together back onto a single parallel data bus. For example, an egress multiplexer 46 can aggregate the data packets from the various data planes in an alternating or ping pong fashion (e.g., a data packet routed from the first data plane 40-1 may be followed by a data packet routed from the second data plane 40-2, whereas a data packet routed from the second data plane 40-2 may be followed by a data packet routed from the first data plane 40-1). Each multiplexer 46 may contain egress buffering (see, e.g., egress buffers 48) and/or may make use of flow control algorithms to control the flow of data packets from the switching/forwarding function being performed by the data planes. The aggregated data packets produced at the output of multiplexer 46 may be conveyed to a corresponding network interface transmitter 36 via parallel data bus 56. Data packets being aggregated on parallel data bus 56 can be packed in a back-to-back arrangement with or without any gaps between consecutive data packets.

During the operations of block 108, the aggregated data packets can be converted to corresponding data bits for transmission. For example, a network interface transmitter 36 can encode the data packets into data bits in preparation for transmission via a corresponding egress port 24. The egress data bits can then be forwarded to another network device, sometimes referred to as a next hop device.

The operations of FIG. 4 are illustrative. In some embodiments, one or more of the described operations may be modified, replaced, or omitted. In some embodiments, one or more of the described operations may be performed in parallel. In some embodiments, additional processes may be added or inserted between the described operations. If desired, the order of certain operations may be reversed or altered and/or the timing of the described operations may be adjusted so that they occur at slightly different times. In some embodiments, the described operations may be distributed in a larger system.

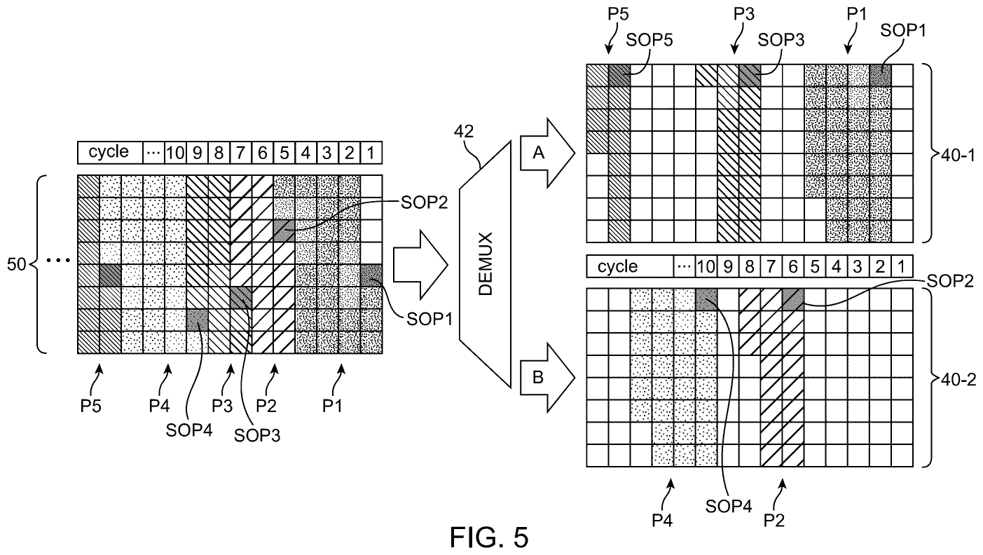

FIG. 5 is a diagram illustrating an example where incoming data packets can be routed to at least two separate/independent data planes. As shown in FIG. 5, a stream of packets such as packets P1, P2, P3, P4, and P5 may be packed back-to-back (without any gaps) between successive packets on the segmented parallel data bus. Here, the segmented parallel data bus may be 8 bytes wide (e.g., the parallel data bus can convey up to 8 bytes of data in parallel during each clock cycle). In the example of FIG. 5, the first data packet P1 may occupy a first number of bytes, beginning with a first start-of-packet byte SOP1 and optionally terminating with a first end-of-packet byte. The first data packet P1 may be conveyed over 5 cycles (e.g., from cycle 1 to cycle 5).

The second data packet P2 may occupy a second number of bytes, beginning with a second start-of-packet byte SOP2 and optionally terminating with a second end-of-packet byte. The second number of bytes may be equal to or may be different than the first number of bytes, as shown in the example of FIG. 5. The second data packet P2 may be conveyed over 3 cycles (e.g., from cycle 5 to cycle 7). The third data packet P3 may occupy a third number of bytes, beginning with a third start-of-packet byte SOP3 and optionally terminating with a third end-of-packet byte. The third number of bytes may be equal to or may be different from the second number of bytes, as shown in the example of FIG. 5. The third data packet P3 may be conveyed over 3 cycles (e.g., from cycle 7 to cycle 9). The fourth data packet P4 may occupy a fourth number of bytes, beginning with a fourth start-of-packet byte SOP4 and optionally terminating with a fourth end-of-packet byte. The fourth number of bytes may be equal to or may be different from the third number of bytes, as shown in the example of FIG. 5. The fourth data packet P4 may be conveyed over 5 cycles (e.g., from cycle 9 to cycle 13). Packet P5 and one or more subsequent packets may be conveyed in this way.

Demultiplexer 42 may be configured to route packets to first data plane 40-1 and to second data plane 40-2 in an alternating fashion. Here, the first data packet P1 may be routed to first data plane 40-1 from cycle 2 to cycle 5. The second data packet P2 may then be routed to second data plane 40-2 from cycle 6 to cycle 8. The third data packet P3 may then be routed to first data plane 40-1 from cycle 8 to cycle 10. The fourth data packet P4 may then be routed to second data plane 40-2 from cycle 10 to cycle 13. If desired, a subsequent data packet can be conveyed in the next cycle, as shown in the example where P1 ends in cycle 5 and P2 starts in the next cycle 6. If desired, a subsequent data packet can be conveyed in the same cycle, as shown in the example where P2 ends in cycle 8 but P3 also starts in the same cycle 8. Data packets can populate two or more data paths in this way in an alternating or round-robin fashion.

The example of FIG. 5 in which data plane 40-1 is an 8-byte-wide parallel data path and in which data plane 40-2 is an 8-byte-wide parallel data path, which has the same data width as the incoming segmented parallel data bus 50 is illustrative. As another example, data plane 40-1 and data plane 40-2 can each have a parallel data bus width that is narrower than that of the incoming parallel data bus 50. As another example, data plane 40-1 and 40-2 can each have a parallel data bus width that is wider than that of the incoming parallel data bus 50.

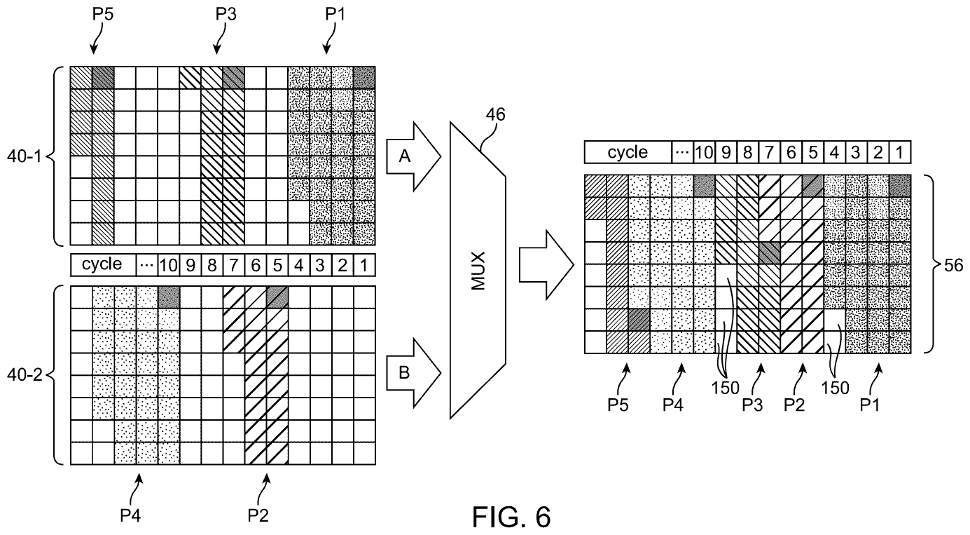

FIG. 6 is a diagram showing how the data packets in the two data planes 40-1 and 40-2 from the example of FIG. 5 can be aggregated using a multiplexer 46. As shown in FIG. 6, the data packets can be aggregated onto a single (segmented) parallel data bus 56 that is 8 bytes wide (as an example). Data packet P1 may be transferred to parallel data bus 56 from cycle 1 to cycle 4. Data packet P2 may be transferred to parallel data bus 56 from cycle 5 to cycle 7. Data packet P3 may be transferred to parallel data bus 56 from cycle 7 to cycle 9. Data packet P4 may be transferred to parallel data bus 56 from cycle 10 to cycle 13, and so on. If desired, a subsequent data packet can be conveyed in the next cycle, as shown in the example where P1 ends in cycle 4 and P2 starts in the next cycle 5. As a result, there can be gaps 150 or empty slots in parallel data bus 56 (e.g., two bytes in parallel data bus 56 might be unutilized in cycle 4). If desired, a subsequent data packet can be conveyed in the same cycle, as shown in the example where P2 ends in cycle 7 while P3 also starts in the same cycle 7. As such, there may be no gaps between data packets P2 and P3. Starting data packets on the next free cycle can help achieve a fixed alignment of fields in the data packets relative to their start of packet pointers, which can help simplify the packet processing pipeline.

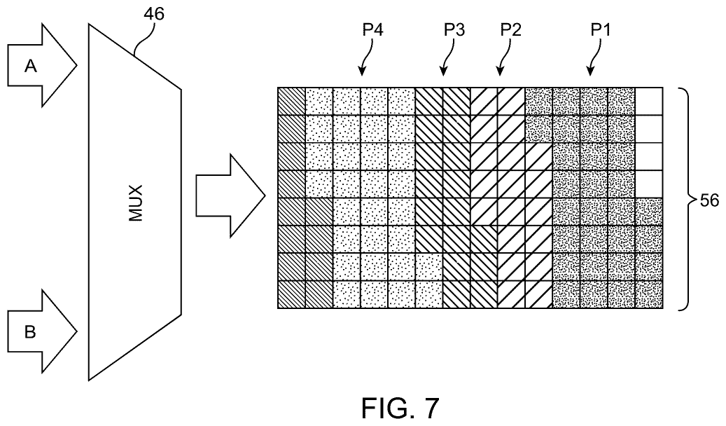

The example of FIG. 6 in which there might be gaps 150 such as two empty bytes between data packets P1 and P2 and gaps 150 such as four empty bytes between data packets P3 and P4 is merely illustrative. FIG. 7 shows another example in which the data packets aggregated on the segmented parallel data bus 56 are packed back-to-back without any gaps between successive data packets. As shown in FIG. 7, the start-of-packet of data packet P2 starts immediately after the trailing end of data packet P1; the start-of-packet of data packet P3 starts immediately after the trailing end of data packet P2; the start-of-packet of data packet P4 starts immediately after the trailing end of data packet P3; and so on. Each data packet on parallel data bus 56 can have the same length or can have different lengths, as shown in the example of FIG. 7.

The foregoing embodiments may be configured as part of a larger system. Such system may be part of a digital system or a hybrid system that includes both digital and analog subsystems. Device 10 may be included as part of a system employed in a wide variety of applications as part of a larger computing system, which may include but is not limited to: a datacenter, a financial system, an e-commerce system, a web hosting system, a social media system, a healthcare/hospital system, a computer networking system, a data networking system, a digital signal processing system, an energy/utility management system, an industrial automation system, a supply chain management system, a customer relationship management system, a graphics processing system, a video processing system, a computer vision processing system, a cellular base station, a virtual reality or augmented reality system, a network functions virtualization platform, an artificial neural network, an autonomous driving system, a combination of at least some of these systems, and/or other suitable types of computing systems.

The methods and operations described above in connection with FIGS. 1-7 may be performed by the components of a network device using software, firmware, and/or hardware (e.g., dedicated circuitry or hardware). Software code for performing these operations may be stored on non-transitory computer readable storage media (e.g., tangible computer readable storage media) stored on one or more of the components of the network device. The software code may sometimes be referred to as software, data, instructions, program instructions, or code. The non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of the network device (e.g., processor 12 and/or processor 16 of FIG. 1).

The foregoing is merely illustrative and various modifications can be made to the described embodiments. The foregoing embodiments may be implemented individually or in any combination.

What is claimed is:

1. A method of operating a network device, comprising:
obtaining incoming data packets;
conveying the incoming data packets through a parallel data bus; and
with a demultiplexer, splitting the incoming data packets being conveyed through the parallel data bus onto a plurality of separate data paths within the network device.

2. The method of claim 1, further comprising:
with an ingress port, receiving data bits; and
with a network interface receiver, converting the received data bits to obtain the incoming data packets.

3. The method of claim 2, further comprising:
buffering at least some of the incoming data packets being conveyed through the parallel data bus.

4. The method of claim 1, further comprising:
packing the incoming data packets back-to-back on the parallel data bus.

5. The method of claim 1, wherein splitting the incoming data packets comprises routing the incoming data packets to the plurality of data paths in an alternating fashion.

6. The method of claim 1, wherein:
the parallel data bus has a first bus width;
a first of the plurality of data paths has a second bus width equal to the first bus width; and
a second of the plurality data paths has a third bus width equal to the first bus width.

7. The method of claim 1, wherein:
the parallel data bus has a first bus width;
a first of the plurality of data paths has a second bus width less than the first bus width; and
a second of the plurality of data paths has a third bus width equal to the second bus width.

8. The method of claim 1, further comprising:
with a multiplexer, aggregating data packets from the plurality of data paths onto an egress parallel data bus.

9. The method of claim 8, wherein at least some of the data packets being aggregated onto the egress parallel data bus are separated by one or more gaps.

10. The method of claim 8, wherein at least some of the data packets being aggregated onto the egress parallel data bus are not separated by any gaps.

11. The method of claim 8, further comprising:
with a network interface transmitter, converting the aggregated data packets on the egress parallel data bus into corresponding output data bits; and
transmitting the output data bits via an egress port.

12. The method of claim 11, further comprising:
buffering at least some of the aggregated data packets traversing through the multiplexer.

13. A method of operating a network device, comprising:
conveying first data packets through a first parallel data path;
conveying second data packets through a second parallel data path; and
with a multiplexer, aggregating the first data packets being conveyed through the first parallel data path and the second data packets being conveyed through the second parallel data path onto an egress parallel data bus.

14. The method of claim 13, wherein:
the first parallel data path has a first bus width; and
the second parallel data path has a second bus width equal to the first bus width.

15. The method of claim 14, wherein the egress parallel data bus has a third bus width equal to the first bus width.

16. The method of claim 14, wherein the egress parallel data path has a third bus width greater than the first bus width.

17. The method of claim 13, wherein at least some of the data packets being aggregated onto the egress parallel data bus are separated by one or more gaps.

18. The method of claim 13, wherein at least some of the data packets being aggregated onto the egress parallel data bus are not separated by any gaps.

19. The method of claim 13, further comprising:
obtaining incoming data packets based on data bits received via an ingress port;
conveying the incoming data packets through an ingress parallel data bus; and
with a demultiplexer, splitting the incoming data packets being conveyed through the ingress parallel data bus into the first data packets to be conveyed through the first parallel data path and the second data packets to be conveyed through the second parallel data path.

20. A network device comprising:
one or more ingress ports;
a network interface receiver coupled to the one or more ingress ports and configured to output incoming data packets;
a demultiplexing circuit configured to receive the incoming data packets from the network interface receiver and to split the incoming data packets into two or more independent data planes;
a multiplexing circuit configured to aggregate data packets being conveyed through the two or more independent data planes;
a network interface transmitter configured to receive the aggregated data packets from the multiplexing circuit; and
one or more egress ports coupled to the network interface transmitter.
